(19) United States
(12) Patent Application Publication
(10) Pub. No.: US 2026/0138384 A1
(43) Pub. Date: May 21, 2026

(54) RECORDING DEVICE

(71) Applicant: SEIKO EPSON CORPORATION, TOKYO (JP)

(72) Inventors: Takehiro SHIN, SHIOJIRI-SHI (JP); Soshi OKAWA, SHIOJIRI-SHI (JP); Yuichi ARUGA, OKAYA-SHI (JP)

(21) Appl. No.: 19/388,086

(22) Filed: Nov. 13, 2025

(30) Foreign Application Priority Data
Nov. 15, 2024 (JP) 2024-199484

(51) Int. Cl. B41J 13/02; B41J 2/165; B41J 11/00; B41J 13/076; B41J 23/12

(52) U.S. Cl. CPC B41J 13/025; B41J 2/16544; B41J 11/006; B41J 13/076; B41J 23/12

(57) ABSTRACT

A recording device includes a pressing member that presses a second roller toward a first roller, and an adjustment mechanism that adjusts pressing force by the pressing member. The adjustment mechanism includes first and second rotation cams provided on the rotation shaft, and an adjustment member that engages with the first and second rotation cams and that also engages with the pressing member, and that adjusts the pressing force by being displaced by rotation of the first and second rotation cams. The first rotation cam includes a first cam surface that reduces the pressing force when the motor rotates in a first rotation direction, and the second rotation cam includes a second cam surface that has a gentler slope than the first cam surface and that increases the pressing force when the motor rotates in a second rotation direction that is opposite to the first rotation direction.

The present application is based on, and claims priority from JP Application Serial Number 2024-199484, filed Nov. 15, 2024, the disclosure of which is hereby incorporated by reference herein in its entirety.

### BACKGROUND

### 1. Technical Field

The present disclosure relates to a recording device that performs recording on a medium.

### 2. Related Art

There was a problem that when a paper jam occurs in a state where a recording sheet is nipped between a fixing roller and a pressure roller, the recording sheet can tear when a user removes the recording sheet by hand. The image forming device described in JP-A-2017-102213 takes this problem into consideration and is configured to be switchable between a high-pressure mode, in which the pressure contact force of a pressure roller is a high load, and a low-pressure mode, in which the pressure contact force is a low load that is smaller than the high load. Switching between the high-pressure mode and the low-pressure mode is performed by rotation of a rotation cam.

The drive motor that rotationally drives the fixing roller also serves as a motor for driving the rotation cam.

In the case where a motor for driving another section also serves as a motor for driving a rotation cam as in the image forming device described in JP-A-2017-102213, sometimes a restriction is imposed when the rotation cam is driven. Although a specific example of this restriction will be described in detail later, there is a case where sufficient motor rotation amount cannot be secured when the pressure contact force is reduced due to the restriction. In this case, it is necessary to form the cam surface of the rotation cam with a steep gradient. However, with this configuration, an excessive load is applied to the motor when the rotation cam is rotated in the direction of increasing the pressure contact force. This causes various problems such as it becomes impossible to switch the load to the direction of increasing the pressure contact force, and it becomes necessary to adopt a high-standard motor causing an increase in the size and cost of the device.

### SUMMARY

A recording device according to the present disclosure for solving the above-described problem includes a transport path configured to transport a medium; a recording section configured to perform recording on the medium in the transport path; a pair of transport rollers that is provided in the transport path and that includes a first roller and a second roller, the second roller being pressed toward the first roller; a pressing member configured to press the second roller toward the first roller; an adjustment mechanism configured to adjust pressing force of the pressing member; and a motor that is a power source of the adjustment mechanism, wherein the adjustment mechanism includes a rotation shaft configured to be rotated by power of the motor, a first rotation cam provided on the rotation shaft, a second rotation cam provided on the rotation shaft, and an adjustment member configured to engage with the first rotation cam and with the second rotation cam and also to engage with the pressing member, the adjustment member being configured to adjust the pressing force by being displaced by rotation of the first rotation cam and the second rotation cam, the first rotation cam includes a first cam surface configured to reduce the pressing force when the motor rotates in a first rotation direction, the second rotation cam includes a second cam surface that is a cam surface having a gentler gradient than the first cam surface and that is configured to increase the pressing force when the motor rotates in a second rotation direction that is opposite from the first rotation direction, and when rotation direction of the motor is switched from the first rotation direction to the second rotation direction, the first rotation cam starts rotating later than the second rotation cam.

### BRIEF DESCRIPTION OF THE DRAWINGS

FIG. 1 is a diagram illustrating a medium transport path of a printer.

FIG. 2 is a side view of an adjustment mechanism that adjusts a pressing force and of a line head.

FIG. 3 is an operation transition diagram in a case where the line head moves between a recording position and a wiping position.

FIG. 4 is a diagram illustrating a positional relationship between an edge detection section and a medium when edge detection is performed.

FIG. 5 is a perspective view of a first rotation cam and a second rotation cam.

FIG. 6 is a perspective view of the second rotation cam.

FIG. 7 is a perspective view of the first rotation cam.

FIG. 8 is a plan view of the second rotation cam as viewed from a rotation shaft direction.

FIG. 9 is a plan view of the first rotation cam as viewed from the rotation shaft direction.

FIG. 10 is a front view of the first rotation cam, the second rotation cam, and the cam engaging section as viewed from a direction orthogonal to the rotation shaft.

FIG. 11A is a side view of an adjustment mechanism.

FIG. 11B is a side view of the adjustment mechanism.

FIG. 11C is a side view of the adjustment mechanism.

FIG. 11D is a side view of the adjustment mechanism.

FIG. 11E is a side view of the adjustment mechanism.

FIG. 11F is a side view of the adjustment mechanism.

FIG. 11G is a side view of the adjustment mechanism.

FIG. 11H is a side view of the adjustment mechanism.

### DESCRIPTION OF EMBODIMENTS

The present disclosure will be schematically described below.

A recording device according to a first aspect includes a transport path configured to transport a medium; a recording section configured to perform recording on the medium in the transport path; a pair of transport rollers that is provided in the transport path and that includes a first roller and a second roller, the second roller being pressed toward the first roller; a pressing member configured to press the second roller toward the first roller; an adjustment mechanism configured to adjust pressing force of the pressing member; and a motor that is a power source of the adjustment mechanism, wherein the adjustment mechanism includes a rotation shaft configured to be rotated by power of the motor, a first rotation cam provided on the rotation shaft, a second rotation cam provided on the rotation shaft, and an adjustment member configured to engage with the first rotation cam and with the second rotation cam and also to engage with the pressing member, the adjustment member being configured to adjust the pressing force by being displaced by rotation of the first rotation cam and the second rotation cam, the first rotation cam includes a first cam surface configured to reduce the pressing force when the motor rotates in a first rotation direction, the second rotation cam includes a second cam surface that is a cam surface having a gentler gradient than the first cam surface and that is configured to increase the pressing force when the motor rotates in a second rotation direction that is opposite from the first rotation direction, and when rotation direction of the motor is switched from the first rotation direction to the second rotation direction, the first rotation cam starts rotating later than the second rotation cam.

According to the aspect, the first rotation cam includes the first cam surface that reduces the pressing force when the motor rotates in the first rotation direction. Therefore, when the motor rotates in the first rotation direction, the pressing force decreases, and medium positioned between the first roller and the second roller can be easily removed.

The second rotation cam includes the second cam surface that is a cam surface having a gentler gradient than the first cam surface and that increases the pressing force when the motor rotates in a second rotation direction, which is opposite to the first rotation direction. Therefore, when, after rotating in the first rotation direction, the motor rotates to switch the rotation direction to the second rotation direction, the pressing force increases, and the medium can be reliably nipped between the first roller and the second roller.

Here, when the rotation direction of the motor is switched from the first rotation direction to the second rotation direction, the first rotation cam starts rotating later than the second rotation cam, and thus the second cam surface functions when the pressing force is increased. Since the second cam surface is a cam surface having a gentler gradient than the first cam surface, it is possible to suppress the load applied to the motor when the pressing force is increased.

As described above, by the configuration in which the cam surface that functions is different between the case of decreasing the pressing force and the case of increasing the pressing force, the first cam surface can be formed to have a steeper slope than the second cam surface, and the rotation amount of the motor for decreasing the pressing force can be suppressed.

By this, in a configuration in which the motor is used as a motor that drives not only the adjustment mechanism but also another part, even when the rotation amount of the motor is restricted due to driving the other part, it is possible to cope with this.

A second aspect is an aspect according to the first aspect, wherein the second rotation cam is configured to rotate in synchronization with the rotation shaft, the first rotation cam is provided so as to be rotatable relative to the rotation shaft, one of the first rotation cam and the second rotation cam is provided with a groove extending along a circumferential direction, the other of the first rotation cam and the second rotation cam is provided with a pin that enters the groove, and when rotation direction of the motor is switched from the first rotation direction to the second rotation direction, the pin moves from a one-side inner wall of the groove to an other-side inner wall of the groove and, by this, the first rotation cam starts to rotate later than the second rotation cam.

According to this aspect, a configuration in which the first rotation cam starts rotating later than the second rotation cam can be easily provided using the groove and the pin.

A third aspect is an aspect according to the second aspect, wherein the adjustment member includes a first cam engaging section configured to engage with the first rotation cam and a second cam engaging section configured to engage with the second rotation cam, a first circumferential surface having a constant outer diameter is formed in an outer peripheral surface of the first rotation cam in addition to the first cam surface, a second circumferential surface having a constant outer diameter is formed in an outer peripheral surface of the second rotation cam in addition to the second cam surface, and an outer diameter at the second circumferential surface is smaller than an outer diameter at the first circumferential surface.

According to this aspect, since the outer diameter of the second circumferential surface is smaller than the outer diameter of the first circumferential surface, the relative rotation between the first rotation cam and the second rotation cam can be reliably realized by the frictional force between the first rotation cam and the first cam engaging section. This will be described in detail later.

A fourth aspect is an aspect according to the third aspect, wherein the first cam engaging section and the second cam engaging section are integrally formed and the first rotation cam and the second rotation cam are provided adjacent to each other in an axial direction of the rotation shaft.

According to this aspect, the first cam engagement section and the second cam engagement section are integrally formed, and the first rotation cam and the second rotation cam are provided adjacent to each other in the axial direction of the rotation shaft, and thus the adjustment mechanism for one second roller can be configured compactly.

A fifth aspect is an aspect according to the first aspect, wherein the adjustment member is provided to be swingable, the second roller is supported by a swingable roller support member, the pressing member is configured by a tension coil spring having one end hooked on the adjustment member and an other end hooked on the roller support member, and the pressing force is changed by the one end of the tension coil spring being displaced by the adjustment member swinging.

According to this aspect, the operational effect of the first aspect described above is obtained by a configuration in which the pressing force changes as the adjustment member swings and the one end of the tension coil spring is displaced.

In should be noted that this aspect is not limited to the first aspect, and may be according to any one of the second to fourth aspects.

A sixth aspect is an aspect according to the first aspect, wherein the first cam surface overlaps the second rotation cam as viewed from an axial direction of the rotation shaft by the motor rotating in the second rotation direction and when the rotation direction of the motor is switched from the second rotation direction to the first rotation direction, the first rotation cam starts rotating later than the second rotation cam and, by this, the overlap of the first cam surface with the second rotation cam is eliminated.

In a case where the first cam surface overlaps the second rotation cam when viewed from the axial direction of the rotation shaft as a result of the motor rotating in the second rotation direction, if the overlap is not eliminated even when the motor rotates in the first rotation direction, then the first cam surface will not function when the pressing force is reduced. As a result, the rotation amount of the motor for reducing the pressing force cannot be suppressed.

However, according to the present aspect, when the rotation direction of the motor is switched from the second rotation direction to the first rotation direction, the first rotation cam starts to rotate later than the second rotation cam, and thus the overlap of the first cam surface with the second rotation cam is eliminated. By this, the first cam surface reliably functions when the pressing force is reduced, and the rotation amount of the motor for reducing the pressing force can be suppressed.

In should be noted that this aspect is not limited to the first aspect, and may be according to any one of the second to fifth aspects.

A seventh aspect is an aspect according to any one of the first to sixth aspects, and further includes a facing section that faces the recording section, wherein the recording section is provided so as to be movable in a direction of advancing and retracting with respect to the facing section, the motor also serves as a power source for moving the recording section, when the motor rotates in the first rotation direction, the recording section is separated from the facing section, and when the motor rotates in the second rotation direction, the recording section advances toward the facing section.

According to this aspect, since the motor also serves as a power source for moving the recording section, it is possible to simplify the configuration and reduce the cost.

An eighth aspect is an aspect according to the seventh aspect, wherein the recording section includes a recording head configured to perform recording on a medium, the recording device further includes a wiper configured to wipe a head surface of the recording head by moving along a width direction of the medium transported on the transport path and an edge detection section that is provided in a wiping section including the wiper and that is configured to detect an edge of the medium in the width direction by moving along the width direction, a position of the recording head in a movement direction includes a recording position at which recording is performed on a medium, a wiping position that is a position separated from the facing section further than is the recording position and that is a position at which the wiper wipes the head surface, a wiping retracted position that is a position separated from the facing section further than is the wiping position and that is a position when the edge detection section detects an edge of the medium in the width direction, and a jam process position which is a position separated further from the facing section than the wiping retracted position and to which the recording head moves when a jam occurs in the transport path, and the adjustment mechanism is configured such that the first cam surface functions and the pressing force decreases in a process of moving from the wiping retracted position to the jam process position.

In the configuration in which the edge detection section is provided in the wiping section, the posture of the medium needs to be stable while the wiping section moves in the width direction and the edge detection section detects the edge of the medium. That is, while the edge detection section detects the edge of the medium, the medium needs to be reliably nipped between the first roller and the second roller. Therefore, when the recording head is located at the wiping retracted position, the pressing force needs to be maintained in a strong state, and the pressing force needs to be reduced in a limited region between the wiping retracted position and the jam process position. That is, it is necessary to reduce the pressing force with a small rotation amount of the motor.

According to the aspect, since the adjustment mechanism is configured such that the first cam surface functions and the pressing force decreases in the process of moving from the wiping retracted position to the jam process position, the pressing force can be decreased with a small rotation amount of the motor.

Hereinafter, the present disclosure will be described in detail.

Hereinafter, an ink jet printer 1 will be described as an example of a recording device that performs recording on a medium. Hereinafter, the ink jet printer 1 is simply referred to as a printer 1.

In should be noted that an X-Y-Z coordinate system illustrated in each drawing is an orthogonal coordinate system, and a direction in which an arrow is directed is a + direction, and the opposite direction is a − direction. The X-axis direction is the width direction of the device, and is the width direction of the medium on which recording is performed. The +X direction is the left side and the −X direction is the right side when viewed from the operator of the printer 1. Hereinafter, the X-axis direction may be referred to as a medium width direction or simply as a width direction.

The Y axis direction is an device depth direction, and is a direction along a medium transport direction at the time of recording. The +Y direction is a direction from the back surface of the device toward the front surface, and the −Y direction is a direction from the front surface of the device toward the back surface. In the present embodiment, among the side surfaces constituting the periphery of the printer 1, the side surface in the +Y direction is the front surface of the device, and the side surface in the −Y direction is the rear surface of the device.

The Z-axis direction is a direction along the vertical direction and is the device height direction. The +Z direction is a vertically upward direction, and the −Z direction is a vertically downward direction.

In should be noted that in the following description, a direction in which a medium is fed may be referred to as “downstream”, and a direction opposite thereto may be referred to as “upstream”.

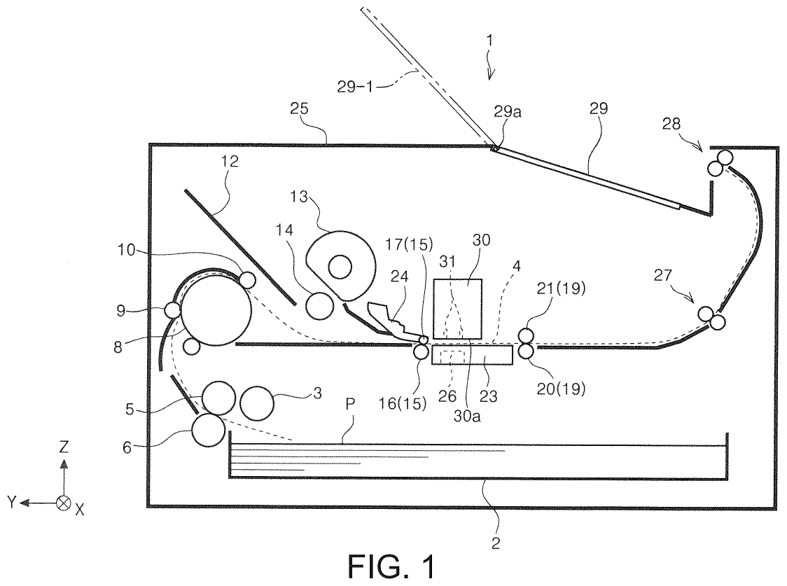

Hereinafter, a medium transport path of the printer 1 will be described with reference to FIG. 1. In the printer 1, the medium is transported along a medium transport path 4 indicated by broken line.

More specifically, the printer 1 includes a medium accommodation cassette 2 at the bottom of the device. Reference numeral P denotes a medium stored in the medium accommodation cassette 2. An example of the medium is a recording paper sheet. The medium accommodation cassette 2 is provided so as to be attachable and detachable from the front side of the device.

A pick up roller 3 driven by a motor (not illustrated) is provided above the medium accommodation cassette 2. The pick up roller 3 can advance and retract with respect to the medium accommodated in the medium accommodation cassette 2, and sends out the medium from the medium accommodation cassette 2 in the +Y direction by rotating in contact with the medium accommodated in the medium accommodation cassette 2.

A feed roller 5 driven by a motor (not illustrated) and a separation roller 6 to which a rotational torque is applied by a torque limiter (not illustrated) are provided downstream of the medium accommodation cassette 2. The medium fed from the medium accommodation cassette 2 is separated and further fed downstream by being nipped by the feed roller 5 and the separation roller 6.

A reversing roller 8 driven by a motor (not illustrated) is provided downstream of the feed roller 5 and the separation roller 6. A first nip roller 9 and a second nip roller 10 are provided around the reversing roller 8, and the medium is nipped by the reversing roller 8 and the first nip roller 9, and further nipped by the reversing roller 8 and the second nip roller 10, and is transported. The transport direction of the medium is reversed from the +Y direction to the −Y direction by the reversing roller 8, and the medium is transported downstream.

A first transport roller pair 15 including a drive roller 16 driven by a motor (not illustrated) and a driven roller 17 that can be driven to rotate is provided downstream of the reversing roller 8. The drive roller 16 is an example of a first roller, and the driven roller 17 is an example of a second roller. The medium is transported to a position facing the line head 30 by the first transport roller pair 15.

The driven roller 17 is supported by a roller support member 24. The driven roller 17 is pressed toward the drive roller 16 by a pressing member (to be described later).

In should be noted that in addition to the medium feeding path from the medium accommodation cassette 2, the printer 1 includes a medium feeding path from the medium support section 12. The medium support section 12 supports the medium in an inclined posture, and the supported medium is transported to the first transport roller pair 15 by the feed roller 13 driven by a motor (not illustrated). Reference numeral 14 denotes a separation roller to which a rotational torque is applied by a torque limiter (not illustrated).

The line head 30 constitutes a recording section that performs recording on a medium. The line head 30 is an example of a recording head that performs recording by ejecting ink, which is an example of a liquid, onto a medium. The line head 30 is a liquid ejection head in which a plurality of nozzles 31 for ejecting ink are arranged so as to cover the entire region in the medium width direction. The line head 30 is elongated in the medium width direction and is configured as a liquid ejection head capable of recording on the entire medium width without moving in the medium width direction.

Reference numeral 30a is the head surface that faces the medium. The head surface 30a can also be referred to as a liquid ejection surface or a nozzle surface. The head surface 30a is parallel to the transport direction of the medium at the position where the medium faces the line head 30, that is, is parallel to the Y-axis direction. The head surface 30a is parallel to the X-Y plane.

The printer 1 includes an ink storage section (not illustrated), and the ink ejected from the line head 30 is supplied from the ink storage section to the line head 30 via an ink tube (not illustrated).

A facing section 23 is provided at a position opposing the head surface 30a of the line head 30. The facing section may be referred to as a platen. The facing section 23 according to the present embodiment includes a shutter (not illustrated) that can open and close, and the facing section 23 supports the medium in a state where the shutter is closed. Hereinafter, the gap between the facing section 23 and the head surface 30a may be referred to as a platen gap.

A cap section 26 is provided at the lower side of the shutter, and when the shutter is opened, the cap section 26 and the head surface 30a can be opposed to each other. Although described in detail later, the line head 30 is provided so as to be able to move up and down, and the cap section 26 can cover the head surface 30a by the line head 30 moving down in a state in which the shutter is open.

A second transport roller pair 19 including a drive roller 20 driven by a motor (not illustrated) and a driven roller 21 that can be driven to rotate is provided downstream of the line head 30. The medium that was recording on is sent downstream by the second transport roller pair 19.

The driven roller 21 is pressed toward the drive roller 20 by a pressing member (not illustrated). However, since the driven roller 21 comes into contact with the recording surface of the medium that was recorded on, the driven roller 21 is pressed toward the drive roller 20 with a pressing force lower than the pressing force of the driven roller 17 described above. That is, the force with which the medium is nipped by the second transport roller pair 19 is weaker than the force with which the medium is nipped by the first transport roller pair 15.

A third transport roller pair 27 is provided downstream of the second transport roller pair 19, and a discharge roller pair 28 is further provided downstream of the third transport roller pair 27. A face-down discharge path is formed between the third transport roller pair 27 and the discharge roller pair 28, and the medium on which recording was performed is discharged to the discharge tray 29 by the discharge roller pair 28 in a state where the most recently recorded surface faces downward.

In should be noted that the force with which the medium is nipped by the third transport roller pair 27 and the force with which the medium is nipped by the discharge roller pair 28 are weaker than the force with which the medium is nipped by the first transport roller pair 15.

The discharge tray 29 is provided so as to be rotatable about a rotation shaft 29a with respect to a housing 25, which constitutes the outer shell of the printer 1. The shaft 29a line of the rotation shaft center section is parallel to the X-axis. The user can access the inside of the printer 1 by opening the discharge tray 29 as indicated by reference numeral 29-1. For example, in a case where a medium is jammed in the medium transport path 4, that is, when a jam occurs, the jammed medium can be removed by opening the discharge tray 29.

Next, as described above, the line head 30 is provided so as to be movable in the direction of advancing and retracting with respect to the facing section 23, that is, in directions for adjusting the platen gap. In the present embodiment, the direction of adjusting the platen gap is parallel to the Z-axis direction.

Hereinafter, the movement of the line head 30 in the +Z direction may be referred to as “raising”, and the movement in the −Z direction may be referred to as “lowering”.

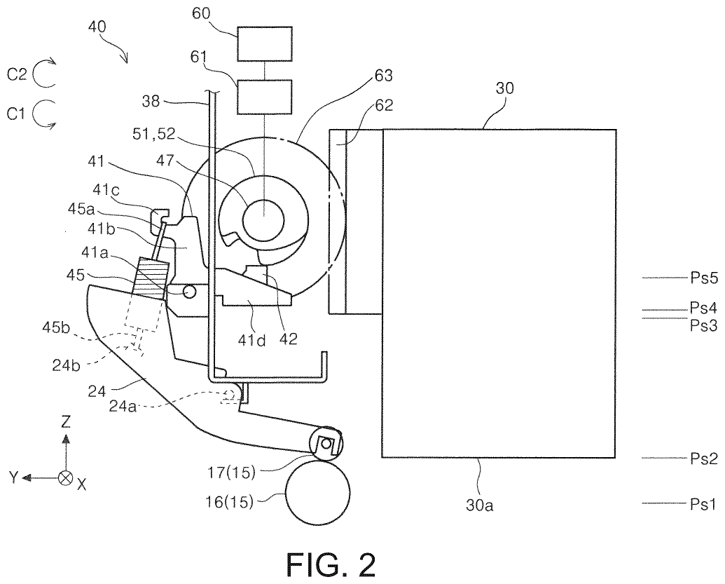

In FIG. 2, reference numeral 61 denotes a head moving motor which is a driving source for raising and lowering the line head 30, and reference numeral 60 denotes a control section which controls the motor 61. The control section 60 is a control section that controls the entire printer 1. The control section 60 includes a CPU, a nonvolatile memory, and the like (not illustrated), and a program, parameters, and the like for controlling the printer 1 are stored in the nonvolatile memory and executed as necessary.

The line head 30 is held by a guide member (not illustrated) so as to be displaceable in the Z-axis direction. A rack section 62 is formed in the line head 30 along the Z-axis direction, and a pinion 63 meshes with the rack section 62 to form a rack and pinion mechanism.

The pinion 63 is provided on a rotation shaft 47, and the rotation shaft 47 rotates by rotation of the motor 61, and the line head 30 is raised and lowered by rotation of the pinion 63.

In should be noted that the rack and pinion mechanism including the rack section 62 and the pinion 63 is provided near both end sections of the line head 30 in the medium width direction.

When the line head 30 is raised, the line head 30 abuts against a rise restricting section (not illustrated), and further raising of the line head 30 is restricted. The control section 60 can grasp that the line head 30 is positioned at the rising limit position by detecting an increase in the motor driving current value when the line head 30 abuts against the rising restriction section.

The motor 61 is provided with an encoder sensor (not illustrated), and the control section 60 can detect the rotation amount of the motor 61. By this, the control section 60 can detect the amount of movement of the line head 30 from the rising limit position, that is, it can grasp the current position of the line head 30.

According to the thickness of the medium based on the medium type included in the received print data, the control section 60 raises and lowers the line head 30 and adjusts the platen gap. For example, when the position of the line head 30 in a case of performing recording on plain paper is set as a first recording position, then, when recording on dedicated paper that is thicker than plain paper, the line head 30 is positioned at a second recording position that is higher than the first recording position.

The movement region of the line head 30 includes other positions in addition to the recording positions described above.

In FIG. 2, reference numerals Ps1, Ps2, Ps3, Ps4, and Ps5 denote positions of the line head 30 with respect to the head surface 30a.

When the line head 30 moves to the position Ps5, which is the uppermost position in the movement region, the platen gap becomes the widest. By this, when a jam occurs, the jammed medium can be removed. Hereinafter, the position Ps5 is referred to as a jam process position Ps5.

The position Ps2 is a recording position when recording is performed on the medium. In should be noted that strictly speaking, the recording position Ps2 includes plural positions that correspond to the thickness of the medium, such as the first recording position and the second recording position described above, but is illustrated as a single position in FIG. 2 for the sake of simplicity.

The position Ps1 is the lowest position. This position is a position where the cap section 26 covers the head surface 30a, and the position Ps1 is hereinafter referred to as a cap position Ps1.

The position Ps3 is a position when the head surface 30a is wiped by a wiper 71 (to be described later). Hereinafter, the position Ps3 is referred to as a wiping position Ps3. In should be noted that after the wiper 71 wipes the head surface 30a, the line head 30 is temporarily raised from the wiping position Ps3 to the position Ps4, and then lowered to the recording position Ps2 or the cap position Ps1. Hereinafter, the position Ps4 is referred to as a wiping retracted position Ps4.

Next, the wiper 71 will be described.

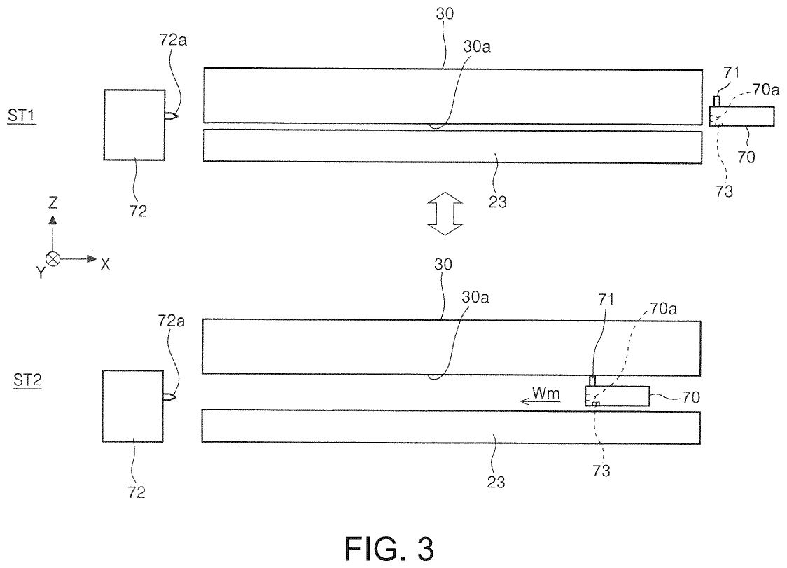

As illustrated in FIG. 3, the printer 1 includes a wiper carriage 70 including the wiper 71. The wiper carriage 70 is movable along the X-axis direction by a motor (not illustrated).

In the present embodiment, it is assumed that the home position of the wiper carriage 70 is the position indicated by a state ST1 in FIG. 3, that is, an end position in the +X direction. When the power supply of the device is off or in a recording standby state, the wiper carriage 70 is positioned at the home position.

The wiper carriage 70 is provided with a wiper 71. The wiper 71 is made of an elastic material such as rubber, and wipes the head surface 30a by the wiper carriage 70 moving in the −X direction in a state of being elastically in contact with the head surface 30a as illustrated by state ST2 in FIG. 3. The ink removed by wiping accumulates in the wiper carriage 70.

A fitting hole 70a is provided at an end section of the wiper carriage 70 in the −X direction. A check valve (not illustrated) is provided in the fitting hole 70a, and the check valve keeps the ink accumulated in the wiper carriage 70 from leaking.

An ink collection section 72 is provided at an end section in the −X direction of the movement region of the wiper carriage 70. The ink collection section 72 has a suction section 72a, and the suction section 72a can be fitted into a fitting hole 70a of the wiper carriage 70. When the wiper carriage 70 moves to the −X direction end section, the suction section 72a fits into the fitting hole 70a. When the suction section 72a is fitted into the fitting hole 70a, the check valve is opened. In this state, the pump (not illustrated) is driven, and thus the ink that has accumulated in the wiper carriage 70 is sucked into and collected in the ink collection section 72.

In should be noted that when the head surface 30a is wiped by the wiper 71, the line head 30 is positioned at the wiping position Ps3 described above. After the wiper carriage 70 moves to the −X direction end section, the line head 30 rises to the wiping retracted position Ps4 described above at the time that the wiper carriage 70 returns to the +X direction end section, that is, to the home position.

Next, an edge detection section 73 provided in the wiper carriage 70 will be described.

The edge detection section 73, which is for detecting the edge of the medium, is provided on the bottom section of the wiper carriage 70.

The edge detection section 73 is an optical sensor, and includes a light emitting section (not illustrated) that emits detection light toward the facing section 23, and a light receiving section (not illustrated) that receives a reflected component of the detection light. The intensity of the reflected component is greater when the detection light is emitted against the medium than when the detection light is emitted against the facing section 23. Therefore, the control section 60 can detect the edge of the medium based on the detection information of the edge detection section 73, and thus can detect the size of the medium in the width direction.

As described above, since the wiper carriage 70 is movable in the medium width direction and the edge detection section 73 is provided on the wiper carriage 70, the edge detection section 73 can perform edge detection by moving the wiper carriage 70 in the medium width direction in a state where the medium is positioned at a position where the medium can be detected by the edge detection section 73. In should be noted that edge detection here means detecting one or both of the +X direction edge and the −X direction edge of the medium.

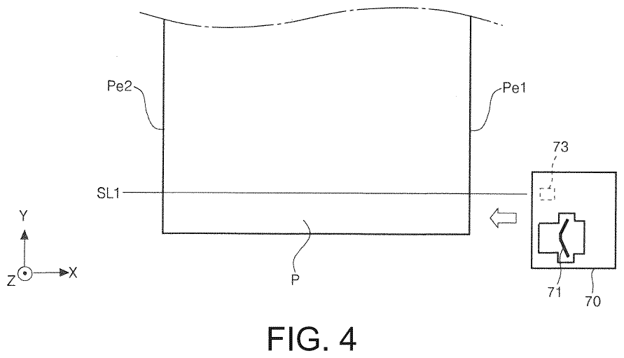

In FIG. 4, reference numeral Pe1 indicates the edge of the medium P in the +X direction, and the reference numeral Pe2 indicates the edge of the medium P in the −X direction. A line SL1 is a detection line of the edge detection section 73. As illustrated in the drawing, the wiper carriage 70, as an example, is moved in the direction of the arrow (−X direction) in a state where the medium P is positioned at a position where the medium P can be detected by the edge detection section 73, and thus the positions of the edge Pe1 and the edge Pe2 can be detected. As a result, the size of the medium P in the width direction can be detected.

In should be noted that by transporting the medium in a state where the medium is positioned at a position where the edge detection section 73 can detect the medium in the medium width direction, for example, at a center position in the medium width direction, it is also possible to detect the edge of the medium in the −Y direction, that is, the leading edge, and the edge of the medium in the +Y direction, that is, the trailing edge.

When edge detection of the medium is performed using the edge detection section 73, the line head 30 may move to the wiping retracted position Ps4 (refer to FIG. 2) after the medium is transported to a position where the medium can face the edge detection section 73, or may move to the wiping retracted position Ps4 before the medium is transported to a position where the medium can face the edge detection section 73.

However, in a case where the edge detection of the medium is performed using the edge detection section 73, it is preferable that the medium is reliably nipped by at least the first transport roller pair 15 so that the posture of the medium does not become unstable.

Next, the adjustment mechanism 40 that adjusts the pressing force when the driven roller 17 is pressed toward the drive roller 16 will be described. Hereinafter, unless otherwise mentioned, pressing force means the pressing force at the time that the driven roller 17 is pressed toward the drive roller 16. In the present embodiment, the pressing force can be switched between a maximum pressing force and a minimum pressing force. In should be noted that the minimum pressing force includes a case where the pressing force is zero.

In FIG. 2, the roller support member 24 is provided to be swingable with respect to the main frame 38 via a swing shaft 24a. The driven roller 17 advances and retracts with respect to the drive roller 16 by the swinging of the roller support member 24.

The roller support member 24 is provided with a spring hooking section 24b. An adjustment member 41 is provided above the roller support member 24. The adjustment member 41 is provided with a spring hooking section 41c. A tension coil spring 45, which is an example of a pressing member, is hooked between the spring hooking section 24b of the roller support member 24 and the spring hooking section 41c of the adjustment member 41. Reference numeral 45a denotes one end of the tension coil spring 45, and the one end 45a is hooked on the spring hooking section 41c. Reference numeral 45b denotes the other end of the tension coil spring 45, and the other end 45b is hooked on the spring hooking section 24b. The spring force of the tension coil spring 45 becomes a force that urges the roller support member 24 to swing in the rotation direction C2, and becomes the pressing force.

In should be noted that the rotation direction C2 is an example of a second rotation direction, and the rotation direction C1 is an example of a first rotation direction.

The adjustment mechanism 40 adjusts the pressing force by displacing the one end 45a of the tension coil spring 45. That is, switching between the maximum pressing force and the minimum pressing force is performed by the adjustment member 41 swinging.

In the present embodiment, the adjustment mechanism 40 includes the rotation shaft 47, a first rotation cam 51, a second rotation cam 52, and the adjustment member 41. The rotation shaft 47 is a shaft that is rotated by the power of the motor 61, and is also a drive source for raising and lowering the line head 30 as described above. The rotation shaft 47 is axially supported by a bearing section (not illustrated) provided in the main frame 38.

The first rotation cam 51 and the second rotation cam 52 are provided on the rotation shaft 47. Although details will be described later, the first rotation cam 51 is not fixedly provided on the rotation shaft 47, and is rotatable relative to the rotation shaft 47. The second rotation cam 52 is fixedly provided on the rotation shaft 47 and always rotates with rotation of the rotation shaft 47.

The adjustment member 41 is provided so as to be swingable with respect to the main frame 38 via the swing shaft 41a. The adjustment member 41 includes a first arm section 41b extending from the swing shaft 41a in the +Z direction and a second arm section 41d extending from the swing shaft 41a in the −Y direction, and the spring hook section 41c described above is provided on the first arm section 41b.

The second arm section 41d is provided with a cam engagement section 42, which is the part that engages with the first rotation cam 51 and the second rotation cam 52. Since a force of swinging in the rotation direction C1 is applied to the adjustment member 41 by the tension coil spring 45, the cam engagement section 42 is in a state of being pressed toward the first rotation cam 51 and the second rotation cam 52.

By this, when the first rotation cam 51 and the second rotation cam 52 rotate, the position of the cam engagement section 42 changes, and by this, the adjustment member 41 swings. When the adjustment member 41 swings, the one end 45a of the tension coil spring 45 is displaced, and the pressing force changes.

As described above, the adjustment member 41 is a member that engages with the first rotation cam 51 and the second rotation cam 52 and that engages with the tension coil spring 45, and adjusts the pressing force by being displaced by the rotation of the first rotation cam 51 and the second rotation cam 52.

Next, the first rotation cam 51 and the second rotation cam 52 will be described.

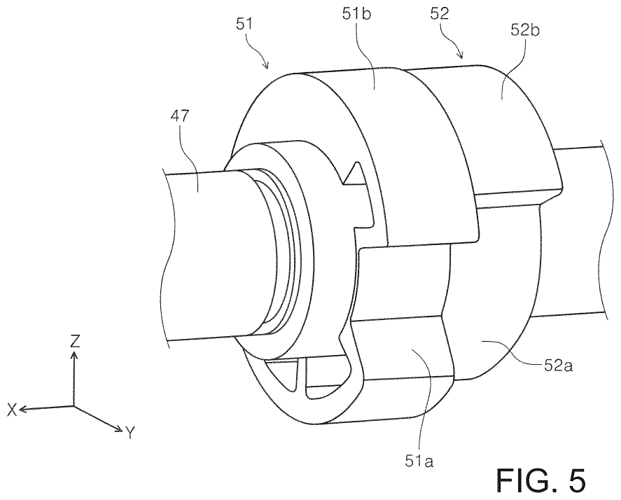

As illustrated in FIG. 5, the first rotation cam 51 and the second rotation cam 52 are provided adjacent to each other in the X-axis direction, that is, in the axial direction of the rotation shaft 47. The axial positions of the first rotation cam 51 and the second rotation cam 52 are regulated by a regulating member (not illustrated), for example, an E-ring, so as not to move in the axial direction. In the present embodiment, the second rotation cam 52 is disposed in the −X direction with respect to the first rotation cam 51.

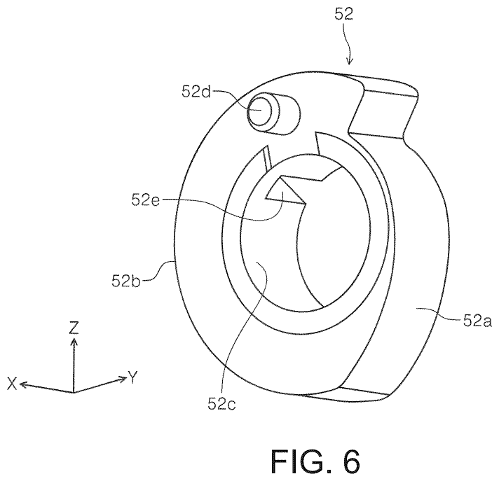

As illustrated in FIG. 6, the second rotation cam 52 has a shaft hole 52c through which the rotation shaft 47 is inserted. A slit 52e extending in the radial direction is formed in the shaft hole 52c, and a protruding section (not illustrated) formed on the rotation shaft 47 is fitted into the slit 52e, so that the second rotation cam 52 rotates integrally with the rotation shaft 47.

A pin 52d is formed on the disc surface of the second rotation cam 52 so as to protrude in the +X direction. A second cam surface 52a and a second circumferential surface 52b are formed on the outer peripheral surface of the second rotation cam 52. In should be noted that the outer peripheral surface of the second rotation cam 52 is formed as a smooth surface over the entire circumference.

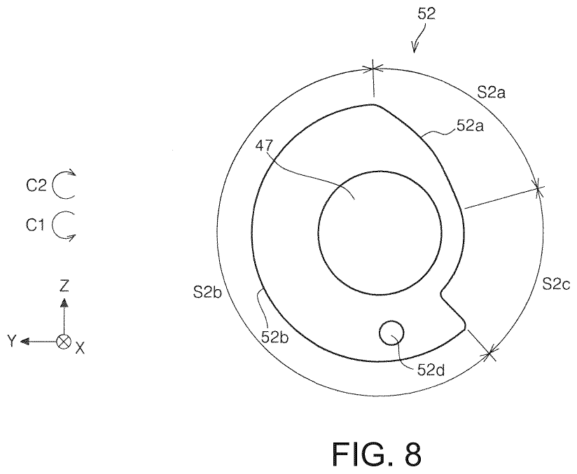

FIG. 8 illustrates the region of the second cam surface 52a and the region of the second circumferential surface 52b, wherein a region S2a is the region of the second cam surface 52a and a region S2b is the region of the second circumferential surface 52b.

The second cam surface 52a is formed so that the radius at the position where the second cam surface 52a abuts the cam engagement section 42 (refer to FIG. 2) gradually increases as the second rotation cam 52 rotates in the rotation direction C2. The second circumferential surface 52b is the part of the second rotation cam 52 having the largest radius, and is a surface where the radius is the same over its entirety.

In should be noted that the region S2c is a region where the radius of the second rotation cam 52 is the smallest.

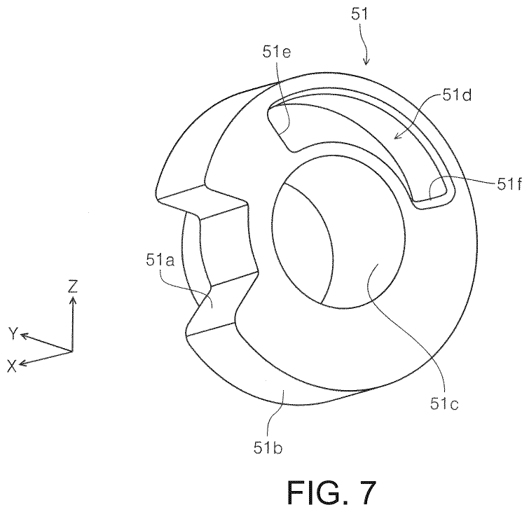

As illustrated in FIG. 7, the first rotation cam 51 has a shaft hole 51c through which the rotation shaft 47 is inserted. The inner diameter of the 51c of the shaft hole is larger than the outer diameter of the rotation shaft 47, and the shaft hole 51c is configured to be in a state that tends not to directly receive torque from the rotation shaft 47 when the rotation shaft 47 rotates.

A groove 51d is formed in the disc surface of the first rotation cam 51 so as to extend in the circumferential direction. Reference numeral 51e is one-side inner wall of the groove 51d, and the reference numeral 51f is the other-side inner wall of the groove 51d. When the first rotation cam 51 and the second rotation cam 52 are adjacent to each other, the pin 52d of the second rotation cam 52 can enter the groove 51d. When the first rotation cam 51 and the second rotation cam 52 rotate relative to each other, the pin 52d can move inside the groove 51d between the one-side inner wall 51e and the other-side inner wall 51f.

A first cam surface 51a and a first circumferential surface 51b are formed on the outer peripheral surface of the first rotation cam 51. In should be noted that the outer peripheral surface of the first rotation cam 51 is formed as a smooth surface over the entire circumference.

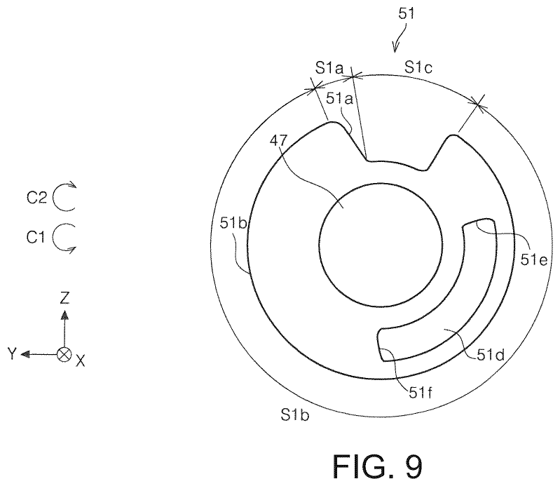

FIG. 9 illustrates a region of the first cam surface 51a and a region of the first circumferential surface 51b, wherein a region S1a is the region of the first cam surface 51a and a region S1b is the region of the first circumferential surface 51b.

The first cam surface 51a is formed so that the radius at the position where the first cam surface 51a abuts on the cam engagement section 42 (refer to FIG. 2) decreases rapidly as the first rotation cam 51 rotates in the rotation direction C1. By this, the first cam surface 51a is a cam surface having a steeper gradient than the second cam surface 52a. In other words, the second cam surface 52a is a cam surface having a gentler gradient than the first cam surface 51a. In other words, the amount of increase in radius per predetermined rotation angle is smaller in the second cam surface 52a than in the first cam surface 51a.

The first circumferential surface 51b is the part of the first rotation cam 51 having the largest radius, and is a surface where the radius is the same over its entirety.

In should be noted that the region S1c is the region where the radius of the first rotation cam 51 is the smallest.

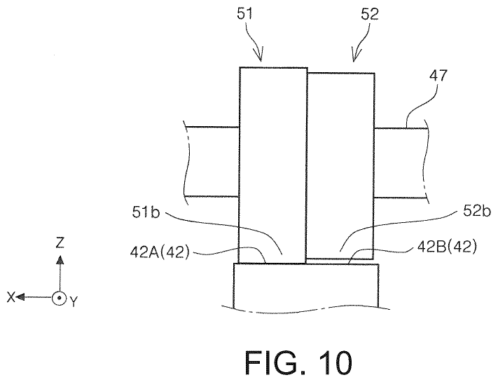

Here, the outer diameter of the first circumferential surface 51b is smaller than the outer diameter of the second circumferential surface 52b. In FIG. 10, reference numeral 42A denotes the part of the cam engagement section 42 that engages with the first rotation cam 51, and will be referred to as a first cam engagement section 42A hereinafter. Reference numeral 42B denotes a part of the cam engagement section 42 that engages with the second rotation cam 52, and will be referred to as a second cam engagement section 42B hereinafter. In the present embodiment, the first cam engagement section 42A and the second cam engagement section 42B are integrally formed. The first cam engagement section 42A and the second cam engagement section 42B are formed to be flush with each other, and are formed so that one does not protrude toward the corresponding cam further than does the other.

As illustrated, since the outer diameter of the first circumferential surface 51b is larger than the outer diameter of the second circumferential surface 52b, the second circumferential surface 52b does not contact the second cam engagement section 42B in a state where the first circumferential surface 51b is pressed against the first cam engagement section 42A.

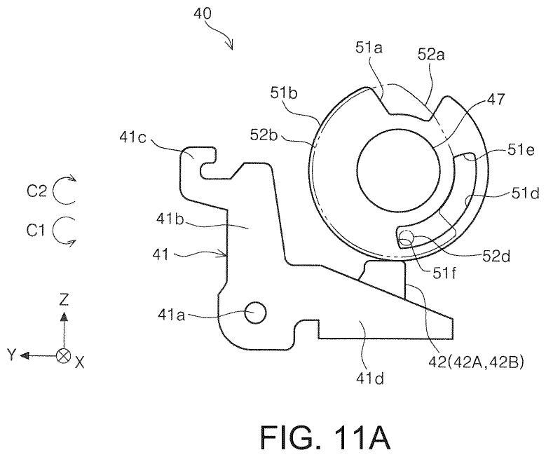

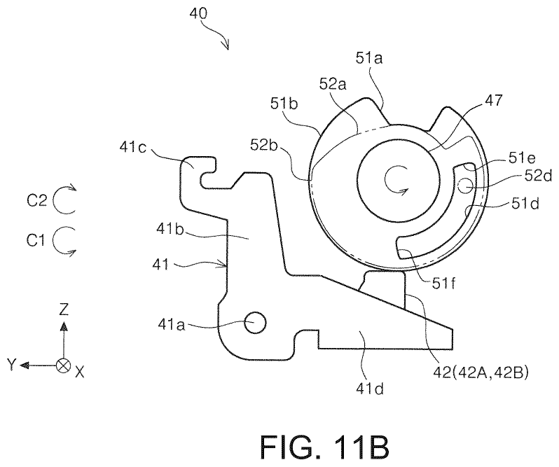

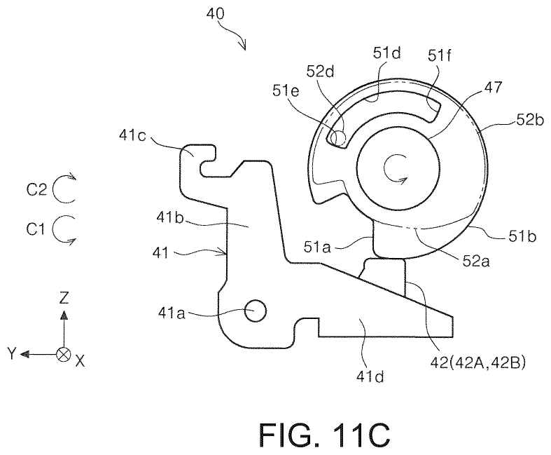

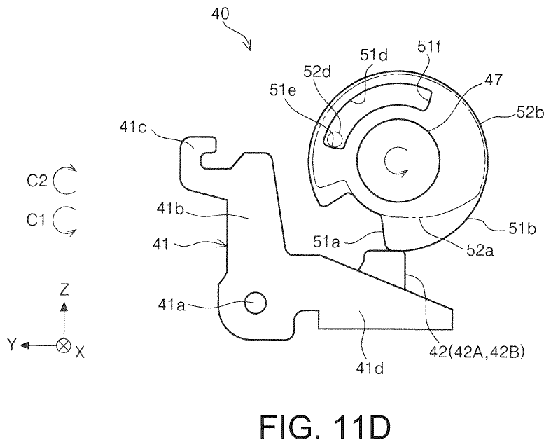

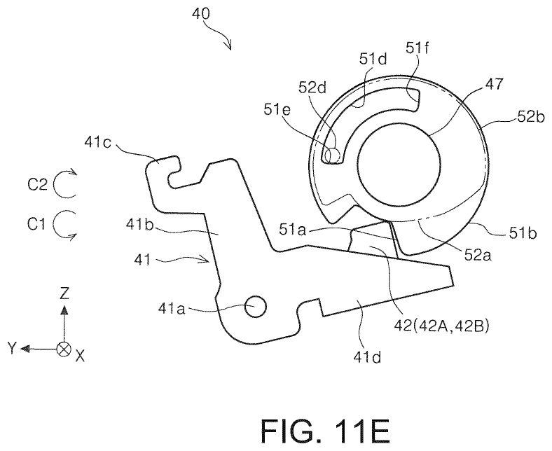

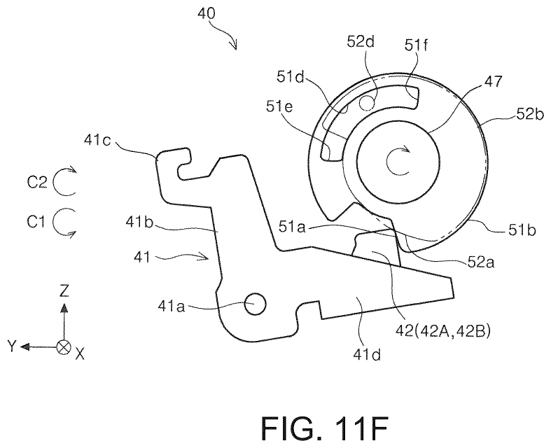

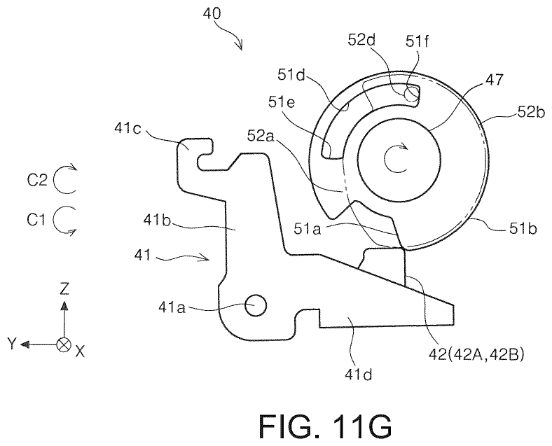

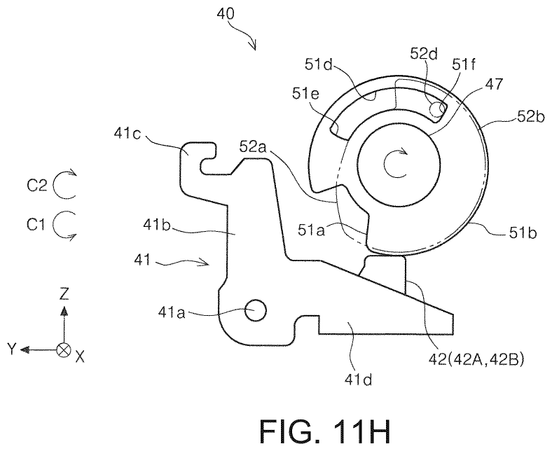

The operation of the adjustment mechanism 40 configured as described above will be described with reference to FIG. 11A to FIG. 11H. In should be noted that in FIG. 11A to FIG. 11H, the second rotation cam 52 and the pin 52d are drawn in two dot chain line in order to illustrate the position of the pin 52d in the groove 51d.

FIG. 11A is a state of the adjustment mechanism 40 when the line head 30 is at the cap position Ps1 (refer to FIG. 2), and is a state of maximum pressing force. In the course of reaching this state, the rotation shaft 47 rotates in the rotation direction C2. At this time, the pin 52d pushes the other-side inner wall 51f of the groove 51d in the rotation direction C2 and, by this, the first rotation cam 51 receives torque from the second rotation cam 52, and the first rotation cam 51 and the second rotation cam 52 rotate integrally in the rotation direction C2.

When the line head 30 is raised from this state, the rotation shaft 47 is rotated in the rotation direction C1. By this, although the second rotation cam 52 also rotates in the rotation direction C1, the first rotation cam 51 does not receive torque from the second rotation cam 52 until the pin 52d abuts against the one-side inner wall 51e of the groove 51d. In addition, the first rotation cam 51 is in contact with the first cam engaging section 42A, and a strong frictional force is generated between them, so that the first rotation cam 51 does not rotate. FIG. 11B illustrates a state in which the line head 30 is raised to the recording position Ps2 (refer to FIG. 2). In this state, the pin side 52d is not in contact with the one-side inner wall 51e of the groove 51d. Therefore, the first rotation cam 51 and the second rotation cam 52 rotate relative to each other.

By the relative rotation of the first rotation cam 51 and the second rotation cam 52, as viewed from the axial direction of the rotation shaft 47 as illustrated in FIG. 11B to FIG. 11E, the second cam surface 52a of the second rotation cam 52 is in a state of not protruding in the radial direction from the first cam surface 51a and the first circumferential surface 51b of the first rotation cam 51. That is, a state in which the first cam surface 51a can function is formed. Therefore, the relative rotation between the first rotation cam 51 and the second rotation cam 52 is important.

When the rotation shaft 47 further rotates in the rotation direction C1 from the state of FIG. 11B, the pin 52d abuts against the one-side inner wall 51e of the groove 51d and pushes the one-side inner wall 51e in the rotation direction C1 and, by this, the first rotation cam 51 receives torque from the second rotation cam 52, and the first rotation cam 51 and the second rotation cam 52 integrally rotate in the rotation direction C1. FIG. 11C illustrates a state in which the line head 30 is raised to the wiping position Ps3 (refer to FIG. 2). As illustrated in the figure, the pin 52d abuts against the one-side inner wall 51e of the groove 51d.

FIG. 11D illustrates a state in which the rotation shaft 47 is further rotated in the rotation direction C1 and the line head 30 is raised to the wiping retracted position Ps4 (refer to FIG. 2). In the processes up to this point, the posture of the adjustment member 41 is maintained by the first circumferential surface 51b abutting against the first cam engagement section 42A. That is, the pressing force is maintained at the maximum pressing force. This state, that is, the posture of the adjustment member 41 illustrated in FIG. 11A to FIG. 11D is referred to as a first posture of the adjustment member 41.

When the rotation shaft 47 further rotates in the rotation direction C1 from this state, the part of the first rotation cam 51 that abuts against the first cam engagement section 42A transitions from the first circumferential surface 51b to the first cam surface 51a. By this, the adjustment member 41 swings in the rotation direction C1 as illustrated by the change from FIG. 11D to FIG. 11E, and the pressing force decreases to the minimum pressing force. FIG. 11E illustrates a state in which the rotation shaft 47 has further rotated in the rotation direction C1, and the line head 30 has been raised to the jam process position Ps5 (refer to FIG. 2).

This state, that is, the posture of the adjustment member 41 illustrated in FIG. 11E, is referred to as a second posture of the adjustment member 41. In this manner, the adjustment member 41 changes its posture between the first posture and the second posture. When the adjustment member 41 is in the first posture, the pressing force is the maximum pressing force. When the adjustment member 41 is in the second posture, the pressing force is the minimum pressing force.

Since the first cam surface 51a has a steep gradient, the adjustment member 41 is switched from the first posture to the second posture, that is, the pressing force is switched from the maximum pressing force to the minimum pressing force, by a small rotation amount of the rotation shaft 47. In this state, since the pressing force is reduced, even when the medium is nipped by the first transport roller pair 15 (refer to FIG. 2), the medium can be pulled out with a small force, and the medium can be suppressed from being torn.

Next, the change in the state of the adjustment mechanism 40 when the line head 30 is lowered from this state will be described. When the line head 30 is to be lowered from the state illustrated in FIG. 11E, the rotation shaft 47 is rotated in the rotation direction C2. By this, although the second rotation cam 52 also rotates in the rotation direction C2, the first rotation cam 51 will not receive torque from the second rotation cam 52 until the pin 52d abuts against the other-side inner wall 51f of the groove 51d. In addition, since the first cam engagement section 42A is in contact with the first cam surface 51a, which is formed with a steep slope, the first rotation cam 51 does not rotate.

Then, the second cam engaging section 42B is pushed down by the second cam surface 52a by rotation of the second rotation cam 52 in the rotation direction C2. FIG. 11F illustrates a state in which this downward pushing has progressed. In the state shown in FIG. 11F, the pin side 52d is not in contact with the other-side inner wall 51f of the groove 51d. When the second cam engagement section 42B is pressed down by the second cam surface 52a, the adjustment member 41 swings in the rotation direction C2, and the pressing force increases.

When the rotation shaft 47 is further rotated from the state illustrated in FIG. 11F, the pin 52d abuts against the other-side inner wall 51f of the groove 51d as illustrated in FIG. 11G. Thereafter, when the rotation shaft 47 rotates in the rotation direction C2, the pin 52d pushes the other-side inner wall 51f in the rotation direction C2 and, by this, the first rotation cam 51 receives torque from the second rotation cam 52, and the first rotation cam 51 and the second rotation cam 52 rotate integrally in the rotation direction C2. In this way, when the rotation direction of the motor 61 is switched from the rotation direction C1 to the rotation direction C2, the first rotation cam 51 starts rotating later than the second rotation cam 52.

As illustrated by the change from FIG. 11F to FIG. 11G, when the second cam engaging section 52a is further pushed down by the second cam surface 42B, the adjustment member 41 approaches the first posture. When the rotation shaft 47 is further rotated from this state, the first circumferential surface 51b of the first rotation cam 51 engages with the first cam engagement section 42A of the cam engagement section 42. Then, the adjustment member 41 is completely switched to the first posture as illustrated in FIG. 11H, the pressing force becomes the maximum pressing force, and it becomes the state in which the medium can be reliably nipped by the first transport roller pair 15.

In this manner, when the adjustment member 41 is switched from the second posture to the first posture, that is, when the load applied to the motor 61 increases, the load applied to the motor 61 can be suppressed because the second cam surface 52a, which has a gentler gradient than the first cam surface 51a, functions.

As described above, the adjustment mechanism 40 includes the rotation shaft 47 that rotates by the power of the motor 61, the first rotation cam 51 provided on the rotation shaft 47, the second rotation cam 52 provided on the rotation shaft 47, and the adjustment member 41 that is a member that engages with the first rotation cam 51 and with the second rotation cam 52 and that also engages with the tension coil spring 45, and that adjusts pressing force by being displaced by rotation of the first rotation cam 51 and the second rotation cam 52.

The first rotation cam 51 includes a first cam surface 51a that reduces the pressing force when the motor 61 rotates in the rotation direction C1. The second rotation cam 52 includes a second cam surface 52a, which is a cam surface that has a gentler gradient than the first cam surface 51a and that increases the pressing force as the motor 61 rotates in the rotation direction C2. When the rotation direction of the motor 61 is switched from the rotation direction C1 to the rotation direction C2, the first rotation cam 51 starts rotating later than the second rotation cam 52.

In this way, when the rotation direction of the motor 61 is switched from the rotation direction C1 to the rotation direction C2, the first rotation cam 51 starts rotating later than the second rotation cam 52, so that the second cam surface 52a functions when the pressing force is to be increased. Since the second cam surface 52a is a cam surface having a gentler gradient than the first cam surface 51a, it is possible to suppress a load applied to the motor 61 when the pressing force is to be increased.

As described above, by the configuration in which the cam surfaces functioning in the case of decreasing the pressing force and the case of increasing the pressing force are different from each other, the first cam surface 51a can be formed to have a steeper gradient than the second cam surface 52a, and the rotation amount of the motor 61 for decreasing the pressing force can be suppressed.

By this, in a configuration in which the motor 61 is used as a motor that drives not only the adjustment mechanism 40 but also other parts, even when the rotation amount of the motor is restricted due to driving other parts, it is possible to cope with this.

An example of this constraint is described below. In the present embodiment, before recording on the medium, sometimes the line head 30 is raised from the recording position Ps2 (refer to FIG. 2) to the wiping retracted position Ps4 (refer to FIG. 2) and, as described with reference to FIG. 4, the width direction size of the medium is detected. At this time, as described above, when the medium is not reliably nipped by the first transport roller pair 15, the posture of the medium becomes unstable, and there is a concern that the width direction size of the medium cannot be appropriately detected. Therefore, in a state where the line head 30 is at the wiping retracted position Ps4 (refer to FIG. 2), the pressing force needs to be maintained in the largest state.

Since the amount of movement of the line head 30 from the wiping retracted position Ps4 (refer to FIG. 2) to the jam process position Ps5 (refer to FIG. 2) is small, it is necessary to reduce the pressing force with a small amount of rotation of the motor 61. In should be noted that if the amount of movement of the line head 30 from the wiping retracted position Ps4 (see FIG. 2) to the jam process position Ps5 (see FIG. 2) is increased, this could lead to an increase in the device size, so is not desirable.

Even in a case where there is a restriction on the rotation amount of the motor 61 in this manner, the adjustment mechanism 40 according to the present embodiment can cope with the restriction.

Hereinafter, the operations and effects of the adjustment mechanism 40 according to the present embodiment will be further described.

The second rotation cam 52 rotates in synchronization with the rotation shaft 47, and the first rotation cam 51 is provided to be rotatable relative to the rotation shaft 47. The first rotation cam 51 is provided with the groove 51d that extends along the circumferential direction, and the other side of the second rotation cam 52 is provided with a pin 51d that enters the groove 52d. When the rotation direction of the motor 61 is switched from the rotation direction C1 to the rotation direction C2, the pin 52d moves from the one-side inner wall 51e of the groove 51d to the other-side inner wall 51f, and by this, the first rotation cam 51 starts to rotate later than the second rotation cam 52.

According to such a configuration, a configuration in which the first rotation cam 51 starts to rotate later than the second rotation cam 52 can be easily obtained by the groove 51d and the pin 52d.

In should be noted that the relationship between the groove and the pin may be reversed. That is, the groove 51d may be formed in the second rotation cam 52, and the pin 52d may be provided in the first rotation cam 51.

The pin 52d does not necessarily have to be provided on the second rotation cam 52. For example, a pin corresponding to the pin 52d is provided on the rotation shaft 47. In this case, the pin is formed so as to protrude in the radial direction from the outer peripheral surface of the rotation shaft 47. In this case, the groove 51d formed in the first rotation cam 51 is formed on the inner peripheral surface of the shaft hole 51c, rather than on the disc surface. With this configuration, when the rotation direction of the motor 61 is switched from the rotation direction C1 to the rotation direction C2, the first rotation cam 51 can start rotating later than the second rotation cam 52.

In this configuration, the first rotation cam 51 and the second rotation cam 52 do not need to be provided adjacent to each other, and may be disposed at positions separated from each other in the axial direction of the rotation shaft 47.

The cam engagement section 42 of the adjustment member 41 includes the first cam engagement section 42A that engages with the first rotation cam 51 and the second cam engagement section 42B that engages with the second rotation cam 52. On the outer peripheral surface of the first rotation cam 51, in addition to the first cam surface 51a, a first circumferential surface 51b having a constant outer diameter is formed. On the outer peripheral surface of the second rotation cam 52, in addition to the second cam surface 52a, a second circumferential surface 52b having a constant outer diameter is formed. The outer diameter of the second circumferential surface 52b is smaller than the outer diameter of the first circumferential surface 51b.

By this, the relative rotation between the first rotation cam 51 and the second rotation cam 52 can be actually realized as described above by the frictional force between the first rotation cam 51 and the first cam engaging section 42A.

In the present embodiment, the first cam engagement section 42A and the second cam engagement section 42B are integrally formed, and the first rotation cam 51 and the second rotation cam 52 are provided adjacent to each other in the axial direction of the rotation shaft 47. According to such a configuration, the adjustment mechanism 40 for a single driven roller 17 can be configured compactly.

However, as described above, the first rotation cam 51 and the second rotation cam 52 may be provided separated from each other in the axial direction of the rotation shaft 47, and in this case, the first cam engagement section 42A and the second cam engagement section 42B may be separately formed.

In the present embodiment, the adjustment member 41 is provided to be swingable, and the driven roller 17 is supported by the swingable roller support member 24. The tension coil spring 45 has one end 45a hooked on the adjustment member 41 and the other end 45b hooked on the roller support member 24. The pressing force is changed by displacement of the one end 45a of the tension coil spring 45 by swinging of the adjustment member 41.

In should be noted that the tension coil spring 45 is an example of a pressing member that presses the driven roller 17 toward the drive roller 16, and that the pressing member is not limited to the tension coil spring 45 and may be another member such as a compression coil spring or a torsion spring.

However, by using the tension coil spring 45 as the pressing member, the tension coil spring 45 can be easily attached after the adjustment member 41 and the roller support member 24 are attached, and the workability of assembly is improved.

In the present embodiment, when the motor 61 rotates in the second rotation direction C2, then as illustrated in FIG. 11A, the first cam surface 51a overlaps the second rotation cam 52 as viewed from the axial direction of the rotation shaft 47. When the rotation direction of the motor 61 is switched from the second rotation direction C2 to the first rotation direction C1, the first rotation cam 51 starts rotating later than the second rotation cam 52 as illustrated in FIG. 11A and FIG. 11B and, by this, the overlap of the first cam surface 51a with the second rotation cam 52 is eliminated.

That is, in a case where, by the motor 61 rotating in the second rotation direction C2, the first cam surface 51a overlaps the second rotation cam 52 as viewed from the axial direction of the rotation shaft 47, if the overlap is not eliminated even when the motor 61 rotates in the first rotation direction C1, then the first cam surface 51a would not function when the pressing force is reduced. As a result, the rotation amount of the motor 61 for reducing the pressing force could not be suppressed.

However, in the present embodiment, when the rotation direction of the motor 61 is switched from the second rotation direction C2 to the first rotation direction C1, the first rotation cam 51 starts rotating later than the second rotation cam 52 and, by this, the overlap of the first cam surface 51a with the second rotation cam 52 is eliminated. By this, the first cam surface 51a reliably functions when the pressing force is reduced, and the rotation amount of the motor 61 for reducing the pressing force can be suppressed.

The printer 1 includes the facing section 23 that faces the line head 30. The line head 30 is provided so as to be movable in the direction of advancing and retracting with respect to the facing section 23, and the motor 61 also serves as a power source of the movement of the line head 30. When the motor 61 rotates in the rotation direction C1, the line head 30 separates from the facing section 23, and when the motor 61 rotates in the rotation direction C2, the line head 30 advances toward the facing section 23.

In this manner, the motor 61 also serves as a power source for moving the line head 30, and thus it is possible to achieve simplification of the configuration and reduction in costs.

The printer 1 has a wiper 71 that wipes the head surface 30a of the line head 30 by moving in the width direction of the medium, and an edge detection section 73 that is disposed on the wiper carriage 70, which includes the wiper 71, and that can detect the width direction edge of the medium by moving in the width direction.

In the adjustment mechanism 40, the first cam surface 51a functions and the pressing force decreases in the course of the movement of the line head 30 from the wiping retracted position Ps4 to the jam process position Ps5.

In the configuration in which the edge detection section 73 is provided in the wiper carriage 70, the posture of the medium needs to be stable as described above while the wiper carriage 70 moves in the width direction and the edge detection section 73 detects the edge of the medium. That is, while the edge detection section 73 is detecting the edge of the medium, the medium needs to be reliably nipped between the drive roller 16 and the driven roller 17. Therefore, when the line head 30 is positioned at the wiping retracted position Ps4, the pressing force needs to be maintained at the maximum pressing force, and the pressing force needs to be reduced in a limited region between the wiping retracted position Ps4 and the jam process position Ps5. That is, it is necessary to reduce the pressing force with a small rotation amount of the motor 61.

According to the present embodiment, since the adjustment mechanism 40 is configured such that the first cam surface 51a functions and the pressing force decreases in the course of the line head 30 moving from the wiping retracted position Ps4 to the jam process position Ps5, the pressing force can be decreased with a small rotation amount of the motor 61.

In should be noted that the printer 1 according to the embodiment has a configuration in which the recording head can perform recording without moving in the width direction, but may have a configuration in which the recording head ejections ink while moving in the width direction, that is, it may be a serial type. The recording method is not limited to an ink jet method, and may be a dot impact method, a laser method, or an electrophotographic method such as an LED method.

In the embodiment described above, the motor 61 serves as both the drive source of the adjustment mechanism 40 and the drive source of the movement of the line head 30, but may serve as both the drive source of the adjustment mechanism 40 and the drive source of other parts.

In the above embodiment, the adjustment mechanism 40 is configured such that the first cam surface 51a functions and the pressing force decreases in the course of moving from the wiping retracted position Ps4 to the jam process position Ps5, but the wiping retracted position Ps4 may be another position.

In particular, as an example, the present disclosure can be applied to a configuration in which the cap section 26 enters between the line head 30 and the facing section 23 when the line head 30 is raised from the recording position Ps2. In this case, the cap section 26 moves in the X-axis direction, for example. Assuming that the position of the line head 30 when the flushing process of ejecting ink to the cap section 26 is performed is set as the flushing position, the adjustment mechanism 40 may be configured such that the first cam surface 51a functions and the pressing force decreases in the course of the line head 30 moving from the flushing position to the jam process position Ps5. Since the flushing process is performed during the recording operation, then in this case, it is necessary to reliably nip the medium by the first transport roller pair 15. In such a configuration, it is desirable that the first cam surface 51a functions and the pressing force decreases in the course of the line head 30 moving from the flushing position to the jam process position Ps5.

Furthermore, the present disclosure is not limited to the embodiments and the modified examples described above, and various modifications are possible within the scope of the disclosure described in the claims, and it is needless to say that they are also included in the scope of the present disclosure.

What is claimed is:

1. A recording device comprising:
a transport path configured to transport a medium;
a recording section configured to perform recording on the medium in the transport path;
a pair of transport rollers that is provided in the transport path and that includes a first roller and a second roller, the second roller being pressed toward the first roller;
a pressing member configured to press the second roller toward the first roller;
an adjustment mechanism configured to adjust pressing force of the pressing member; and
a motor that is a power source of the adjustment mechanism, wherein
the adjustment mechanism includes
a rotation shaft configured to be rotated by power of the motor,
a first rotation cam provided on the rotation shaft,
a second rotation cam provided on the rotation shaft, and
an adjustment member configured to engage with the first rotation cam and with the second rotation cam and also to engage with the pressing member, the adjustment member being configured to adjust the pressing force by being displaced by rotation of the first rotation cam and the second rotation cam,
the first rotation cam includes a first cam surface configured to reduce the pressing force when the motor rotates in a first rotation direction,
the second rotation cam includes a second cam surface that is a cam surface having a gentler gradient than the first cam surface and that is configured to increase the pressing force when the motor rotates in a second rotation direction that is opposite from the first rotation direction, and
when rotation direction of the motor is switched from the first rotation direction to the second rotation direction, the first rotation cam starts rotating later than the second rotation cam.

2. The recording device according to claim 1, wherein
the second rotation cam is configured to rotate in synchronization with the rotation shaft,
the first rotation cam is provided so as to be rotatable relative to the rotation shaft,
one of the first rotation cam and the second rotation cam is provided with a groove extending along a circumferential direction,
the other of the first rotation cam and the second rotation cam is provided with a pin that enters the groove, and
when rotation direction of the motor is switched from the first rotation direction to the second rotation direction, the pin moves from a one-side inner wall of the groove to an other-side inner wall of the groove and, by this, the first rotation cam starts to rotate later than the second rotation cam.

3. The recording device according to claim 2, wherein
the adjustment member includes
a first cam engaging section configured to engage with the first rotation cam and
a second cam engaging section configured to engage with the second rotation cam,
a first circumferential surface having a constant outer diameter is formed in an outer peripheral surface of the first rotation cam in addition to the first cam surface,
a second circumferential surface having a constant outer diameter is formed in an outer peripheral surface of the second rotation cam in addition to the second cam surface, and
an outer diameter at the second circumferential surface is smaller than an outer diameter at the first circumferential surface.

4. The recording device according to claim 3, wherein
the first cam engaging section and the second cam engaging section are integrally formed and
the first rotation cam and the second rotation cam are provided adjacent to each other in an axial direction of the rotation shaft.

5. The recording device according to claim 1, wherein
the adjustment member is provided to be swingable,
the second roller is supported by a swingable roller support member,
the pressing member is configured by a tension coil spring having one end hooked on the adjustment member and an other end hooked on the roller support member, and
the pressing force is changed by the one end of the tension coil spring being displaced by the adjustment member swinging.

6. The recording device according to claim 1, wherein
the first cam surface overlaps the second rotation cam as viewed from an axial direction of the rotation shaft by the motor rotating in the second rotation direction and
the overlap of the first cam surface with the second rotation cam is eliminated by, when the rotation direction of the motor is switched from the second rotation direction to the first rotation direction, the first rotation cam starting to rotate later than the second rotation cam.

7. The recording device according to claim 1, further comprising:
a facing section that faces the recording section, wherein
the recording section is provided so as to be movable in a direction of advancing and retracting with respect to the facing section,
the motor also serves as a power source for moving the recording section,
when the motor rotates in the first rotation direction, the recording section is separated from the facing section, and
when the motor rotates in the second rotation direction, the recording section advances toward the facing section.

8. The recording device according to claim 7, wherein
the recording section includes a recording head configured to perform recording on a medium,
the recording device further includes a wiper configured to wipe a head surface of the recording head by moving along a width direction of the medium transported on the transport path and
an edge detection section that is provided in a wiping section including the wiper and that is configured to detect an edge of the medium in the width direction by moving along the width direction,
a position of the recording head in a movement direction includes
a recording position at which recording is performed on a medium,
a wiping position that is a position separated from the facing section further than is the recording position and that is a position at which the wiper wipes the head surface,
a wiping retracted position that is a position separated from the facing section further than is the wiping position and that is a position when the edge detection section detects an edge of the medium in the width direction, and
a jam process position which is a position separated further from the facing section than the wiping retracted position and to which the recording head moves when a jam occurs in the transport path, and
the adjustment mechanism is configured such that the first cam surface functions and the pressing force decreases in a process of moving from the wiping retracted position to the jam process position.
